(19) United States
(12) Patent Application Publication
(10) Pub. No.: US 2011/0131892 A1
(43) Pub. Date: Jun. 9, 2011

(54) Green Precast Mold

(75) Inventor: Pedro Del Pino, San Juan, PR (US)

(73) Assignee: Pedro Del Pino, San Juan, PR (US)

(21) Appl. No.: 12/633,416

(22) Filed: Dec. 8, 2009

(51) Int. Cl. B28B 7/02; B28B 7/00; E04C 2/06; E04B 1/16

(52) U.S. Cl. 52/125.4; 52/315; 52/576; 52/255; 52/259; 52/646; 52/750

(57) ABSTRACT

A wall molding system using two (2) prefabricated panels, with finished exterior surfaces placed parallel to each other and held from the inside by separators-anchors. The panels may also use exterior fasteners to hold the weight and pressure of the concrete. Insulating material and structural reinforcements may also be placed inside the mold. Concrete would be used to fill the spaces between the panels.

### BACKGROUND

The High construction costs and the environmental impact of construction developments drives us to improve the different ways we work with concrete. Various types of existing molds are heavy and must be removed alter being used in order to work on the plastering of the walls. This process is not only expensive, but time consuming in addition generating great amounts of waste.

Utilizing a mold that does not have to be removed and at the same time already having a finished look saves time, Money and is certainly eco friendly as it eliminates the need to use wood as part of the process to put the concrete in place.

### BRIEF SUMMARY OF THE INVENTION

This wall, column and beam mold consists of to or more prefabricated panels each having a finished/already plastered side. The panels are custom-cut as per the architectural design's specifications, placed parallel to each other and held to each other with various adjustable pieces (spacers-anchors) that are placed between the panels. The function of these spacers-anchors is to maintain the panels separated as per the structural design's specifications and prevents the mold from breaking or opening when filled with concrete. At the same time, the spacers-anchors work as a support for the horizontal structural reinforcements.

The spacers-anchors have and interior borings that allows for the insertion of any type of fastening system that would have an exit on both sides so that the panels can be hold externally in the event that the concrete exerts a great force from the inside of the mold. These spacers-anchors can be manufactured using a variety of materials such as plastic and metal as long as it resists the concrete pressure.

Should it be necessary or required by the design, insulation may be installed inside the mold prior to filling it with concrete. The fusion of various molds creates a monolithic figure, therefore, when filled with concrete the same applies for the interior.

The molds may be located over any surface side by side until the desired distance and height is reached. Horizontal steel reinforcements which run through and rest on the space-anchors are inserted in one end and the vertical reinforcements are installed through the upper boring. Finally the concrete is poured. Once the concrete dries, we obtain a structural wall which already has the exterior finish as part of the prefabricated panels that come with plastering finish.

### BRIEF DESCRIPTION OF SEVERAL VIEWS OF THE DRAWING

FIG. 1. Isometric view of the mold

FIG. 2. Isometric view of a section of the mold

FIG. 3. Isometric view of the mold illustrating the concrete and insulation

FIG. 4. Plan view—Horizontal section of the mold

FIG. 5. Plan view—Horizontal section of the mold illustrating the concrete and insulation

FIG. 6. Elevation of a section of the mold illustrating the concrete and insulation

FIG. 7. Plan view of two sections of the mold illustrating how molds are connected

FIG. 8. Plan view of two sections of the mold connected and illustrating the exterior support of the mold

### DETAILED DESCRIPTION OF THE INVENTION AND DRAWINGS

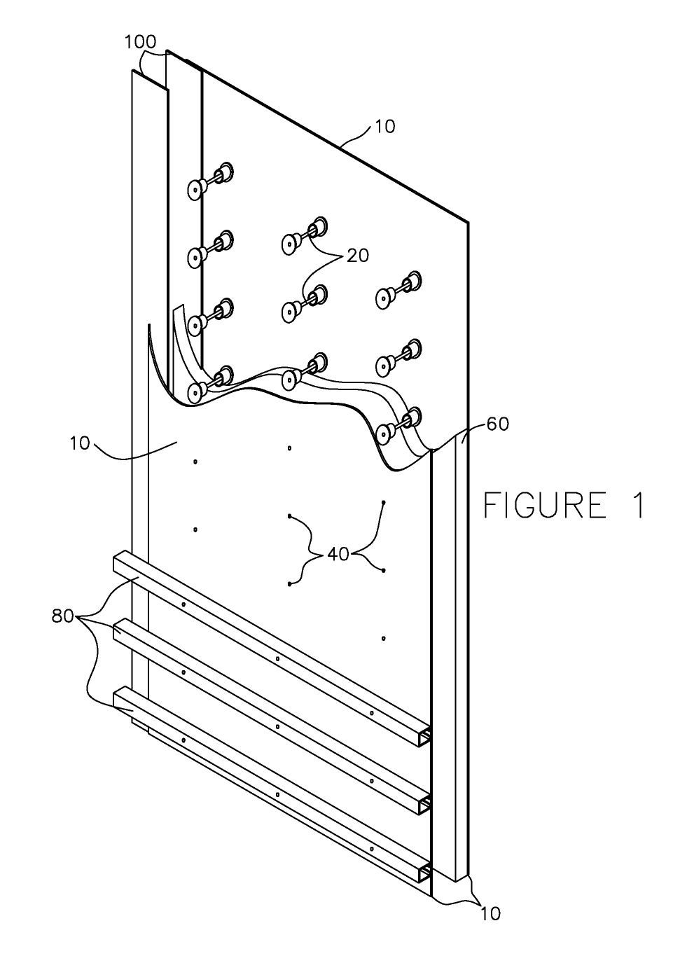

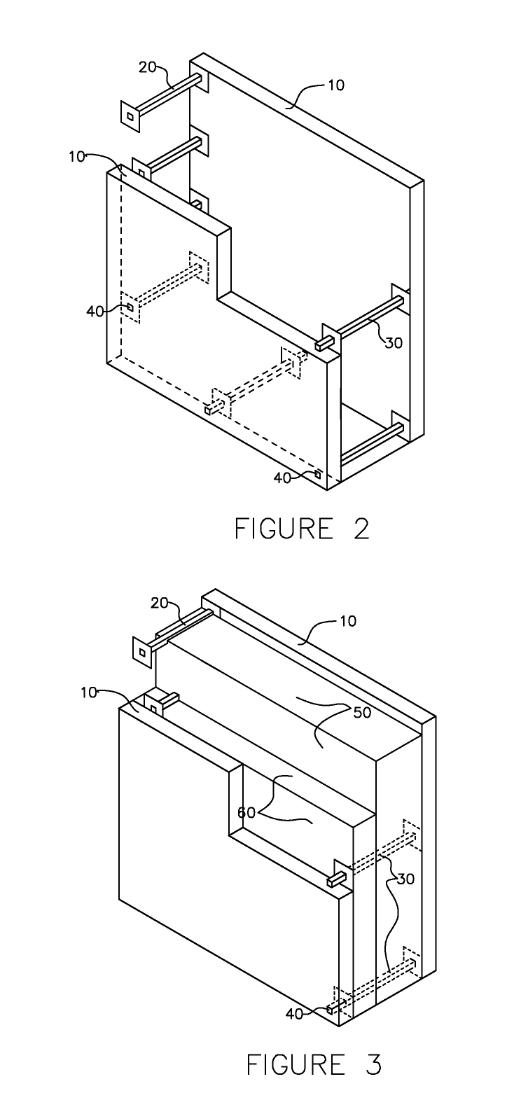

FIG. 1. illustrates a mold with two prefabricated panels 10 which are located parallel to each other and separated by spacers-anchors 20 which allow the formation of a monolithic figure once these are filled with concrete. The prefabricated panels 10 have borings 40 which allow the fastening system to run from side to side 90 in order to hold the exterior supports 80. FIG. 2 illustrates the prefabricated panels 10 with its borings 40 and the types of spacers-anchors 20 and 30, the spacers-anchor 30 enters the mold borings 40 from the inside out to provide it with stability and direct the mold assembly. FIG. 3 illustrates the insulation 60 and the cement 50 inside the mold.

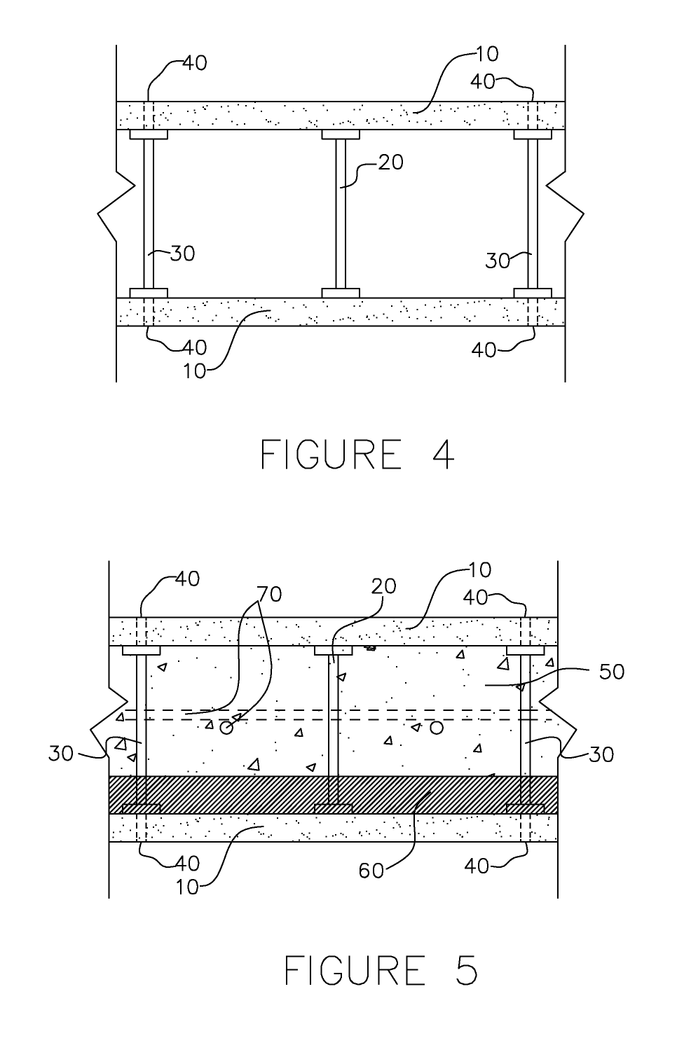

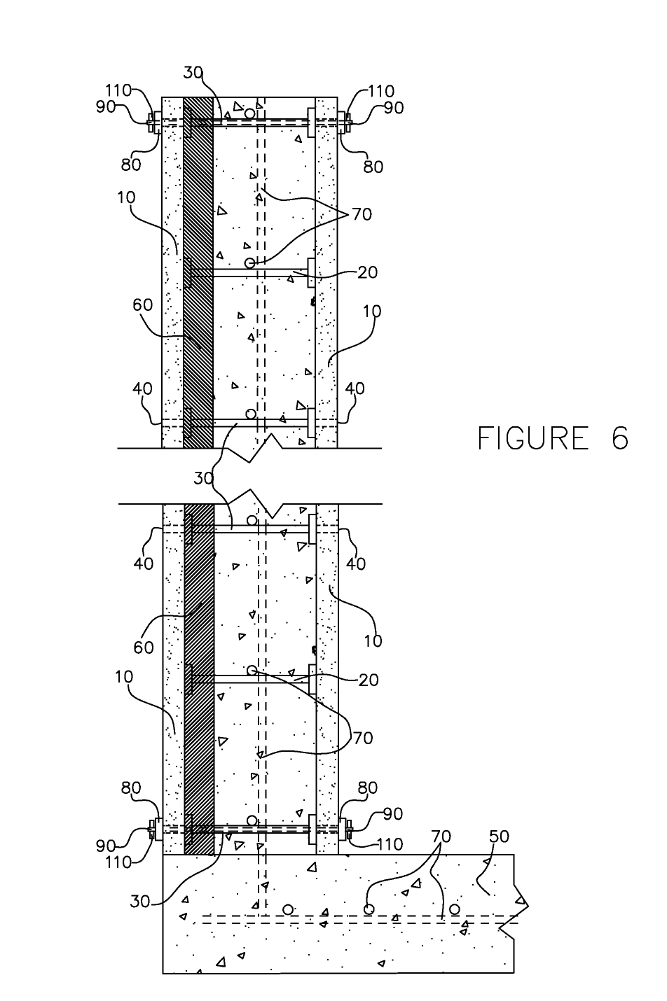

FIG. 4 is a section of the mold illustrating the same as FIG. 2, FIG. 5 is a plan view of FIG. 3.

FIG. 6 is an elevation of a view of a section of the mold over a concrete floor 50 with the structural reinforcement 70. The concrete 50 and the insulation 60 are illustrated inside the two prefabricated panels 10 separated by the spacers-anchors 20 and 30 and the structural supports 70 resting over the spacers-anchors 20 and 30 by the borings 40. In the panels 10 a fastening system is inserted 90 to hold the exterior supports 80 that are kept in place by a bolt 110 or similar object that performs the same function.

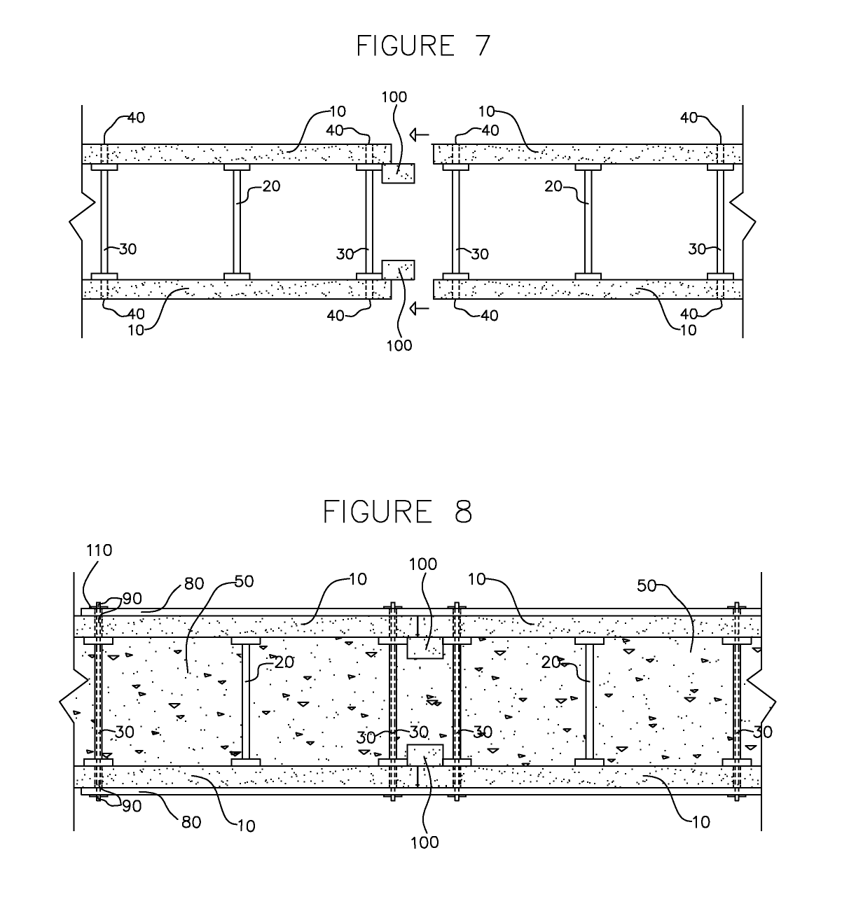

FIG. 7 illustrated a mold being connected to another mold through the guide channel 100. FIG. 8 illustrated to molds held together with the exterior supports 80 which, at the same time are held by a fastening system 90 kept in place by a bolt 110 or similar object that performs the same function, ready to be filled with concrete. This allows for the mold to withstand the pressure exerted by the concrete 50 from the inside out when the molds are being filled, once the concrete 50 has dried, the bolts are removed 110, the exterior support systems 80 and the fastening systems 90. The borings 40 are filled and the molds are then Reddy to be painted.

1. A construction mold that provides a plastering finish.

2. A construction mold that forms insulated structural walls, columns and beams.

3. A construction mold with prefabricated panels with borings.

4. A construction mold that could use exterior supports and once filled with concrete, these supports may be removed without damaging the plastering finish on the mold.

5. A construction mold that can manufacture forming L-shaped corners and T-shaped unions.

6. A construction mold that can manufacture forming wall intersections in the form of a cross (+).

7. A construction mold that may be adjusted to any width, length or depth necessary or required by the structural design.

8. A Construction mold that is environment friendly for the conservation of the planet
